(19) United States
(12) Patent Application Publication
(10) Pub. No.: US 2006/0061111 A1
(43) Pub. Date: Mar. 23, 2006

(54) Bumper with face-mounted reinforcer

(75) Inventor: Guy M. Ignafol, Muskegon, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Shape Corporation

(21) Appl. No.: 11/227,381

(22) Filed: Sep. 15, 2005

Related U.S. Application Data
(60) Provisional application No. 60/611,024, filed on Sep. 17, 2004.

(51) Int. Cl. B60R 19/02

(52) U.S. Cl. 293/102

(57) ABSTRACT

A bumper includes a tubular primary beam, such as a rollformed D-shaped beam made of high-strength steel, with at least one longitudinal channel formed in its face surface. One or more mild steel thin-wall tube sections are positioned in the channel(s) and welded in place for increased strength in selected areas, while permitting overall weight savings in the bumper.

### CROSS REFERENCE TO RELATED APPLICATIONS

This application claims benefit of provisional application Ser. No. 60/611,024, filed Sep. 17, 2004, entitled BUMPER WITH FACE-MOUNTED REINFORCER

### BACKGROUND

The present invention concerns vehicle bumpers.

Bumpers require a balance between weight and performance. An ideal system provides the desired performance and yet has been optimized for weight. Different designs, manufacturing processes, and materials can produce similarly performing bumpers, but the cost and weight will dictate which bumper is used in mass production. Rollformed steel tubular bumpers have gained widespread use due to the fact that they can meet performance requirements, are inexpensive when compared to competing manufacturing processes and material cost, and produce a final design system that on a weight-per-performance basis are very attractive. However, current styling trends and the competitiveness in the automotive industry continue to require every possible marginal change that offers cost savings and/or that reduces weight. These factors have pushed the design envelope of rollformed steel tubular bumpers.

In particular, to meet the demanding requirements of styling and mass production, additional stiffeners have sometimes been added to simple rollformed steel tubular bumpers such as by adding a hat-shaped channel across a center of a bumper beam. These stiffeners are placed to increase beam stiffness at particular locations for the various impacts encountered and tested on bumpers. However, these stiffeners add weight and cost, and can complicate the manufacturing process. The challenge remains to develop bumper beams with stiffeners shaped, positioned, and attached so as to produce a final design that is optimized for weight, cost, and performance.

Thus, a system having the aforementioned advantages and solving the aforementioned problems is desired.

### SUMMARY OF THE PRESENT INVENTION

In one aspect of the present invention, a bumper includes a bumper beam having a length and a primary impact surface with at least one longitudinal channel formed therein. A tubular reinforcer is positioned at least partially in the channel and secured to the bumper beam.

In another aspect of the present invention, a bumper includes a tubular beam having a length and an outer wall. The outer wall has a primary impact surface with at least one longitudinal channel formed therein. An elongated reinforcer is positioned at least partially in the channel and secured to the beam.

In another aspect of the present invention, a bumper includes a beam having an outer wall defining a first curvature. At least one reinforcer has a second curvature different from the first curvature when in an unstressed state, but which is resiliently flexed to a stressed state to match the first curvature and which is attached to the outer wall to reinforce the beam.

These and other aspects, objects, and features of the present invention will be understood and appreciated by those skilled in the art upon studying the following specification, claims, and appended drawings.

### BRIEF DESCRIPTION OF DRAWINGS

FIGS. 1-3 show front, top, and end views of the bumper;

FIGS. 4 and 4A show a front view and a cross section of FIGS. 1-3; and

FIGS. 5-6 show perspective views of FIGS. 1-3.

### DETAILED DESCRIPTION OF PREFERRED EMBODIMENTS

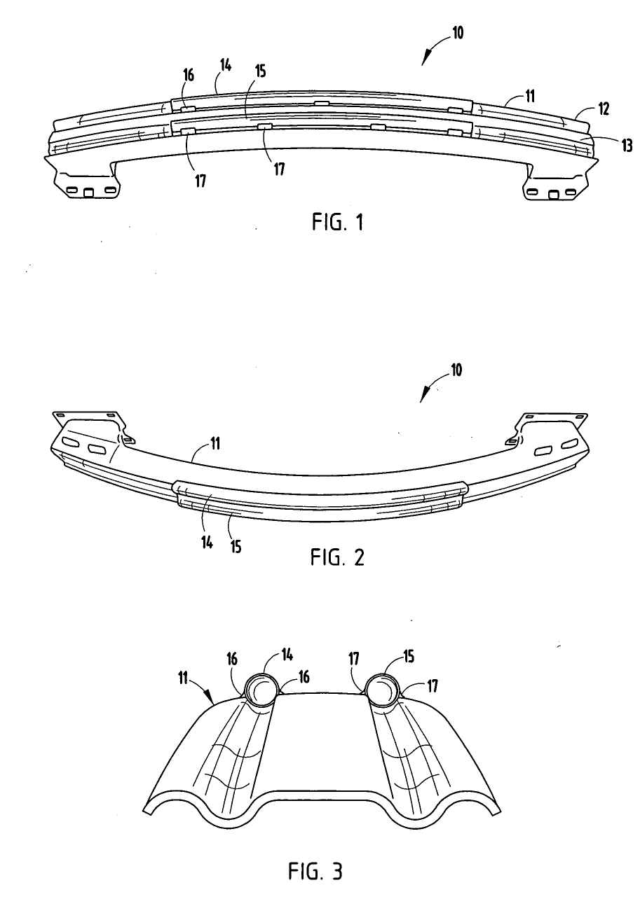

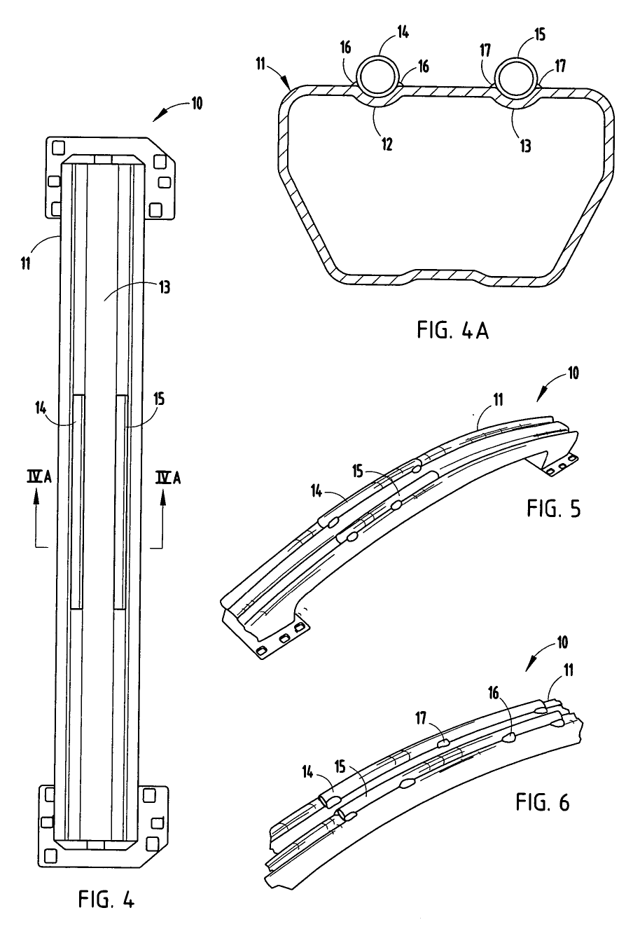

The present invention is a bumper incorporating a type of stiffener (and the process of affixing the stiffener) that optimizes the design for weight, cost, and performance. The illustrated bumper 10 (FIG. 1) includes a rollformed D-shaped tubular beam 11 with longitudinal channels 12, 13 in its face wall, and having a pair of tubular stiffeners 14 and 15 placed therein. However, it is contemplated that the present inventive concepts are not limited to only a tubular beam 11 nor to only a tubular stiffener 14, 15.

Two mild steel thin wall tubular sections 14, 15 (also called “tubes” or “stiffeners” or “reinforcers”) are attached to the front face of the steel tubular bumper beam. The tubes 14, 15 are rollformed or purchased in straight lengths and then resiliently flexed and assembled onto the swept (curved) front face of the beam system. This assembly process puts the tubes into a compression/tension state that, when in a free state, work to pull the manufactured sweep (curvature) out of the beam system. The curvature is not changed in the free-state due to the fact that the tubes are strategically welded at locations along the length of the beam. Required weld locations include at a minimum both ends of the beam and the center of the beam. The sweep curvature is also not changed due to the fact that the tubes are made of mild steel and the bumper beam is made from a much higher strength grade of steel (HSLA, UHSS, or AUHSS). The tubes are also welded at weld locations 16, 17 strategically into recessed pockets (i.e. illustrated as channels 12, 13) that have been rollformed into the front face of the bumper beam. These pockets 12, 13 provide nesting areas for the tubes 14, 15 and provide excellent tangent points between the tubes and beam material where welds 16, 17 can be placed.

On impact, the tubes 14, 15 are the first hard contact surface that makes contact with the striking surface. The bumper 10 may have an energy absorber and a fascia forward of the tubes, but their contribution in absorbing energy is different and has a relatively lesser amount of energy absorption. Upon impact into the bumper 10, the tubes are loaded and will begin to deform. This deformation absorbs some of the impact energy. As impact loading increases, the tubes will continue to deform, causing the curvature of the rollformed beam and the tubes to decrease. As the impact stroke continues, the tubes will begin to force the front face of the beam inward. The curvature of the bumper 10 is harder to remove from the system due to the way the tubes 14, 15 are welded at their ends to the front face of the rollformed bumper beam. This configuration essentially stiffens the rollformed bumper beam and helps it to maintain its curvature during loading. The increase loading required to remove the curvature of the system translates into a higher initial slope of the load vs. deflection curve. An increased slope of the load vs. deflection curve translates to a higher efficient system. (i.e. More impact energy is absorbed and sooner.) Since the tube ends are welded to the front face of the rollformed bumper beam, the tubes will help to reduce the amount of permanent set in the beam once loading is relieved and all energy is absorbed.

An advantage in using mild straight length thin-walled tubing is that no secondary processing is needed to bend the tubes to a radius that matches the rollformed bumper beam. The straight tubes can be either purchased (potentially as a commodity item) or can be manufactured using rollforming. It is contemplated that the decision to purchase or manufacture the tubing will be made based on cost justification and weight considerations. (i.e. The beam 11 weight can potentially be reduced by using a thinner sheet if the tubular stiffeners 14, 15 are added.) The final part will have to be cut to length for the specific application. The secondary process used to attach the tubes to the front face of the rollformed bumper beam will require welding and clamping fixtures that will place and bend the tubes around the front face of the rollformed bumper beam. Below is a step-by-step process needed to manufacture the reinforced bumper.

Process and Build of D-Section with Front Tube Reinforcement.

Beam 11 is made from HSLA, UHSS, or AUHSS material rollformed with 2 radial valleys 12, 13 that run the full length of the beam.

The beam 11 is placed in a secondary weld fixture that will weld on bracket attachments if necessary and will weld on the tubes 14, 15.

Standard EW tube (14, 15) is purchased, cut to length, and is formed to the beam and welded in the rolled pockets. The illustrated EW tubes 14, 15 are centered on the beam 11 in the cross-car position.

After bending of the tubes, the tubes 14, 15 are at a radius that is slightly less (tighter curvature) than the curvature of the bumper beam 11. This allows the tubes to rest on the tangents of the radii that are formed in the front face of the rollformed bumper beam. Welds are spaced to draw load from outboard ends of beams on contact against a flat barrier (i.e. upon a simulated impact). Typical weld placement would include the ends of the tubes and the center of the tubes.

As the beam makes contact at center with flat barrier, the load is absorbed in the tube and works against the radius on the form of the beam.

It is to be understood that variations and modifications can be made on the aforementioned structure without departing from the concepts of the present invention, and further it is to be understood that such concepts are intended to be covered by the following claims unless these claims by their language expressly state otherwise.

I claim:

1. A bumper comprising:
a bumper beam having a length and a primary impact surface with at least one longitudinal channel formed therein; and
a tubular reinforcer positioned at least partially in the channel and secured to the bumper beam.

2. The bumper defined in claim 1, wherein the bumper beam is made of a first metal and the tubular reinforcer is made of a second metal that is lower in tensile strength than the first metal.

3. The bumper defined in clam 2, wherein the bumper beam is tubular.

4. The bumper defined in claim 1, wherein the primary impact surface is curved longitudinally, and the tubular reinforcer has a similar longitudinal curvature.

5. The bumper defined in claim 1, wherein the tubular reinforcer extends a distance less than half of the length of the primary impact surface.

6. The bumper defined in claim 1, wherein the channel has a cross section that includes an arcuate section, and the cross section of the tubular reinforcer has a mating arcuate shape.

7. The bumper defined in claim 1, wherein the primary impact surface includes a second channel that extends parallel the first-mentioned channel, and including a second tubular reinforcer that is positioned at least partially in the second channel and that extends parallel the first-mentioned tubular reinforcer.

8. A bumper comprising:
a tubular beam having a length and an outer wall, the outer wall having a primary impact surface with at least one longitudinal channel formed therein; and
an elongated reinforcer positioned at least partially in the channel and secured to the beam.

9. A bumper comprising:
a beam having an outer wall defining a first curvature; and
at least one reinforcer having a second curvature different from the first curvature when in an unstressed state, but which is resiliently flexed to a stressed state to match the first curvature and which is attached to the outer wall to reinforce the beam.

10. The bumper defined in claim 9, wherein the beam is tubular.

11. The bumper defined in claim 9, wherein the reinforcer is tubular.
